(19) United States
(12) Patent Application Publication
(10) Pub. No.: US 2018/0109409 A1
(43) Pub. Date: Apr. 19, 2018

(54) WIRELESS CONTROL DEVICE, WIRELESS DEVICE, AND BASE STATION

(71) Applicant: FUJITSU LIMITED, Kawasaki-shi (JP)

(72) Inventor: Noboru KOBAYASHI, Tokorozawa (JP)

(73) Assignee: FUJITSU LIMITED, Kawasaki-shi (JP)

(21) Appl. No.: 15/695,763

(22) Filed: Sep. 5, 2017

(30) Foreign Application Priority Data
Oct. 17, 2016 (JP) 2016-203936

(51) Int. Cl. H04L 27/26; H04W 24/10

(52) U.S. Cl. CPC H04L 27/2646; H04W 16/04; H04L 27/2689; H04W 24/10

(57) ABSTRACT

A wireless control device comprising: a communication circuit configured to receive, from a wireless device, a signal wirelessly received by the wireless device; and a control circuit configured to store a time at each reception of a given amount of signal by the communication circuit and perform wireless signal processing of transmitting and receiving a wireless signal through the wireless device, in accordance with a time calculated based on a plurality of stored times.

### CROSS-REFERENCE TO RELATED APPLICATION

This application is based upon and claims the benefit of priority of the prior Japanese Patent Application No. 2016-203936, filed on 17 Oct. 2016, the entire contents of which are incorporated herein by reference.

### FIELD

The embodiment discussed herein is related to a wireless control device, a wireless device, and a base station.

### BACKGROUND

Conventionally, 3GPP has discussed the specifications of mobile communication systems such as the third generation mobile communication system (3G), LTE corresponding to the 3.9th generation mobile communication system, and LTE-Advanced corresponding to the fourth generation mobile communication system. The 3GPP stands for Third Generation Partnership Project. The LTE stands for Long Term Evolution. Discussion on technologies related to the fifth generation mobile communication system (5G) has been started.

In a known technology, a beacon frame is detected in a piconet communication signal received by a piconet member device to determine the boundary of a piconet superframe. In a known configuration, a base station configured to perform wireless communication with a terminal includes a wireless device configured to transmit and receive wireless signals and a wireless control device configured to control the wireless device.

Examples of the related art include Japanese Laid-open Patent Publication No. 2004-266832.

### SUMMARY

According to an aspect of the invention, a wireless control device includes a communication circuit and a control circuit. The communication circuit is configured to receive, from a wireless device, a signal wirelessly received by the wireless device. The control circuit is configured to store a time at each reception of a given amount of signal by the communication circuit and perform wireless signal processing of transmitting and receiving a wireless signal through the wireless device, in accordance with a time calculated based on a plurality of stored times.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary base station according to an embodiment;

FIG. 2 is a diagram illustrating an exemplary wireless device and an exemplary wireless control device according to the embodiment;

FIG. 3 is a diagram illustrating an exemplary wireless signal processing time at the wireless control device according to the embodiment;

FIG. 4 is a diagram illustrating an exemplary wireless signal processing unit according to the embodiment;

FIG. 5 is a diagram illustrating exemplary second synchronization signal correction at the wireless control device according to the embodiment;

FIG. 6 is a diagram illustrating exemplary setting a start time of wireless signal processing at the wireless control device according to the embodiment;

FIG. 7 is a diagram (1) illustrating exemplary prediction of a synchronization-signal generation time according to the embodiment;

FIG. 8 is a diagram (2) illustrating the exemplary prediction of a synchronization-signal generation time according to the embodiment;

FIG. 9 is a flowchart of exemplary initialization processing performed by the wireless control device according to the embodiment;

FIG. 10 is a flowchart of exemplary synchronization processing performed by the wireless control device according to the embodiment; and

FIG. 11 is a diagram illustrating an exemplary hardware configuration of the wireless control device according to the embodiment.

### DESCRIPTION OF EMBODIMENT

In the conventional technology described above, a time available for wireless signal processing at a wireless control device requests to be increased when the time of signal transmission from the wireless device to a wireless control device fluctuates.

For example, when the wireless control device is achieved by, for example, a general-purpose server, it is expected that signal transmission between the wireless device and the wireless control device is asynchronous with transmission and reception of wireless signals by the wireless device. Thus, the time available for wireless signal processing at the wireless control device may not be increased in some cases when the time of signal transmission from the wireless device to the wireless control device fluctuates due to fluctuation in transmission delay between the wireless device and the wireless control device.

In one aspect, the embodiment discussed herein is intended to provide a wireless control device, a wireless device, and a processing method that may increase a time available for wireless signal processing at the wireless control device when the time of signal transmission from the wireless device to a wireless control device fluctuates.

The following describes a wireless control device, a wireless device, and a processing method according to the embodiment in detail with reference to the accompanying drawings.

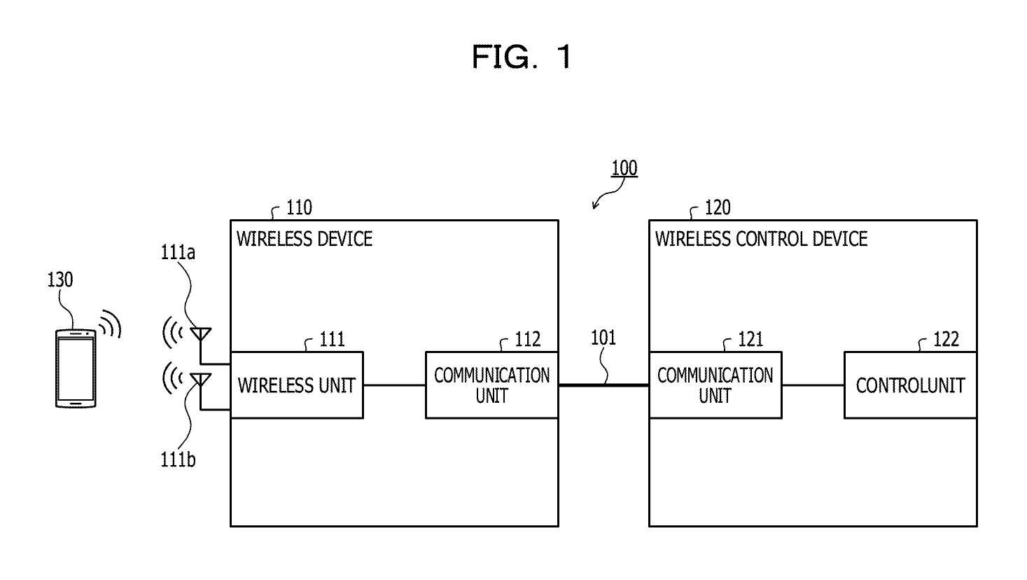

FIG. 1 is a diagram illustrating an exemplary base station according to the embodiment. As illustrated in FIG. 1, a base station 100 according to the embodiment includes a wireless device 110 and a wireless control device 120. The wireless device 110 and the wireless control device 120 are connected with each other through a transmission path 101. The wireless device 110 transmits and receives wireless signals under control of the wireless control device 120. For example, the wireless device 110 includes a wireless unit 111 and a communication unit 112.

The wireless unit 111 includes, for example, antennas 111a and 111b and transmits and receives wireless signals with another communication device through the antennas 111a and 111b. For example, the wireless unit 111 performs wireless communication with a terminal 130. The terminal 130 is a wireless terminal such as 3GPP user equipment (UE; user terminal). The wireless unit 111 may include one antenna to transmit and receive wireless signals through this one antenna. The wireless unit 111 may include three antennas or more to transmit and receive wireless signals through these three antennas or more.

For example, the wireless unit 111 outputs a signal (for example, an uplink signal) wirelessly received from the terminal 130 to the communication unit 112. The wireless unit 111 wirelessly transmits, to the terminal 130 through the antennas 111a and 111b, a signal (for example, downlink signal) output from the communication unit 112. The transmission and reception of wireless signals by the wireless unit 111 are performed for each predetermined amount unit of data. The predetermined amount unit of data is, for example, a sub frame (wireless sub frame).

The communication unit 112 transmits, to the wireless control device 120 through the transmission path 101, a signal output from the wireless unit 111. The communication unit 112 receives a signal transmitted from the wireless control device 120 through the transmission path 101. Then, the communication unit 112 outputs the received signal to the wireless unit 111.

The wireless control device 120 performs wireless signal processing of transmitting and receiving wireless signals through the wireless device 110. This wireless signal processing includes, for example, processing performed at the base station 100 to decode a signal wirelessly received by the base station 100, except for processing performed by the wireless device 110. Examples of the wireless control device 120 include baseband processing units at various base stations such as a 3GPP eNB. Alternatively, the wireless control device 120 is achieved by software executed at, for example, a general-purpose server.

The transmission path 101 is asynchronous with transmission and reception of wireless signals by the wireless unit 111. For example, the transmission path 101 is a transmission path through which signal transmission is performed at a timing asynchronous with the sampling frequency of conversion of a signal wirelessly received by the wireless unit 111 from an analog signal to a digital signal. As an example, the transmission path 101 is a transmission path using Ethernet (registered trademark). However, the transmission path 101 is not limited to Ethernet, but may be a transmission path such as InfiniBand. Connecting the wireless device 110 and the wireless control device 120 through the transmission path 101 asynchronous with transmission and reception of wireless signals by the wireless unit 111 may reduce restriction on hardware for achieving the wireless control device 120.

For example, signal transmission between the wireless device 110 and the wireless control device 120 may be achieved through a general-purpose communication interface such as Ethernet without a dedicated communication interface such as CPRI provided to the wireless control device 120. The CPRI stands for Common Public Radio Interface. Thus, the wireless control device 120 may be achieved by software executed at a general-purpose computer such as a general-purpose server.

The wireless control device 120 includes, for example, a communication unit 121 and a control unit 122. The communication unit 121 receives a signal (for example, an uplink signal) transmitted from the wireless device 110 through the transmission path 101, and outputs the received signal to the control unit 122. The communication unit 121 transmits, to the wireless device 110 through the transmission path 101, a signal (for example, a downlink signal) output from the control unit 122.

The control unit 122 performs wireless signal processing of controlling transmission and reception of wireless signals through the wireless device 110 by communicating with the wireless device 110 through the communication unit 121. In this case, since the transmission path 101 is asynchronous with transmission and reception of wireless signals by the wireless unit 111 as described above, any signal output from the communication unit 121 to the control unit 122 is asynchronous with transmission and reception of wireless signals by the wireless unit 111. Thus, the control unit 122 performs, based on the signal output from the communication unit 121 to the control unit 122 and synchronization for detecting the timing (for example, a boundary at each predetermined unit) of the signal output from the communication unit 121 to the control unit 122.

For example, the control unit 122 stores the current time when each predetermined amount of signal is output from the communication unit 121. The control unit 122 calculates the timing of the signal output from the communication unit 121 to the control unit 122 based on a plurality of times thus stored. This signal timing is, for example, a timing at the boundary of each predetermined unit of signal. The predetermined unit of signal is, for example, the unit of transmission and reception by the wireless device 110 (for example, the unit of sub frame). For example, the control unit 122 calculates the timing of the signal by linear approximation based on a plurality of stored times. Then, the control unit 122 performs the wireless signal processing of controlling transmission and reception of wireless signals by the wireless device 110 based on the calculated timing.

For example, the control unit 122 calculates, based on the stored times, a time (prediction time) in the future at which a predetermined amount (for example, for one sub frame) of signals is received from the wireless device 110, and starts signal decoding processing (for example, Fourier transform) at the calculated prediction time. For example, the control unit 122 generates a synchronization signal indicating the calculated prediction time, in other words, the prediction time of the boundary at each signal predetermined unit, and is triggered by the generated synchronization signal to start the signal decoding processing. The synchronization signal indicates the boundary at each signal predetermined unit.

In this manner, the wireless control device 120 stores a time at each reception of the predetermined amount of signal from the wireless device 110, and performs the wireless signal processing based on a time calculated based on a plurality of times thus stored. Accordingly, when the timing of signal transmission from the wireless device 110 to the wireless control device 120 through the transmission path 101 fluctuates, the wireless control device 120 may calculate a signal timing with less fluctuation and then perform the wireless signal processing. This increases a time available for the wireless signal processing at the wireless control device 120.

The control of transmission and reception of wireless signals by the wireless device 110 includes, for example, processing of decoding a signal transmitted from the wireless device 110 through the transmission path 101, received by the communication unit 121 and output from the communication unit 121 to the control unit 122. The control of transmission and reception of wireless signals by the wireless device 110 also includes, for example, processing of generating a signal to be wirelessly transmitted by the wireless device 110, and transmitting the generated signal to the wireless device 110 through the transmission path 101.

The control unit 122 may start the signal decoding processing (wireless signal processing) at a time earlier than a calculated prediction time (at which signal reception at the next predetermined unit from the wireless device 110 is completed). However, the time earlier than the prediction time is later than, for example, a time at which the signal reception at the next predetermined unit from the wireless device 110 starts.

In this case, the communication unit 121 divides a signal received from the wireless device 110 through the transmission path 101 into a unit smaller than the above-described predetermined amount, and outputs the divided signal to the control unit 122. In other words, the communication unit 121 outputs the signal received from the wireless device 110 through the transmission path 101 to the control unit 122 before the amount of received signal reaches at the predetermined unit. This allows the control unit 122 to start the wireless signal processing at a time earlier than the prediction time.

In this manner, the wireless control device 120 may calculate a time at which a predetermined amount of signal is received from the wireless device 110 based on a plurality of stored times, and start signal decoding processing at a time earlier than the calculated prediction time. This increases a time available for wireless signal processing on a received signal at the base station 100.

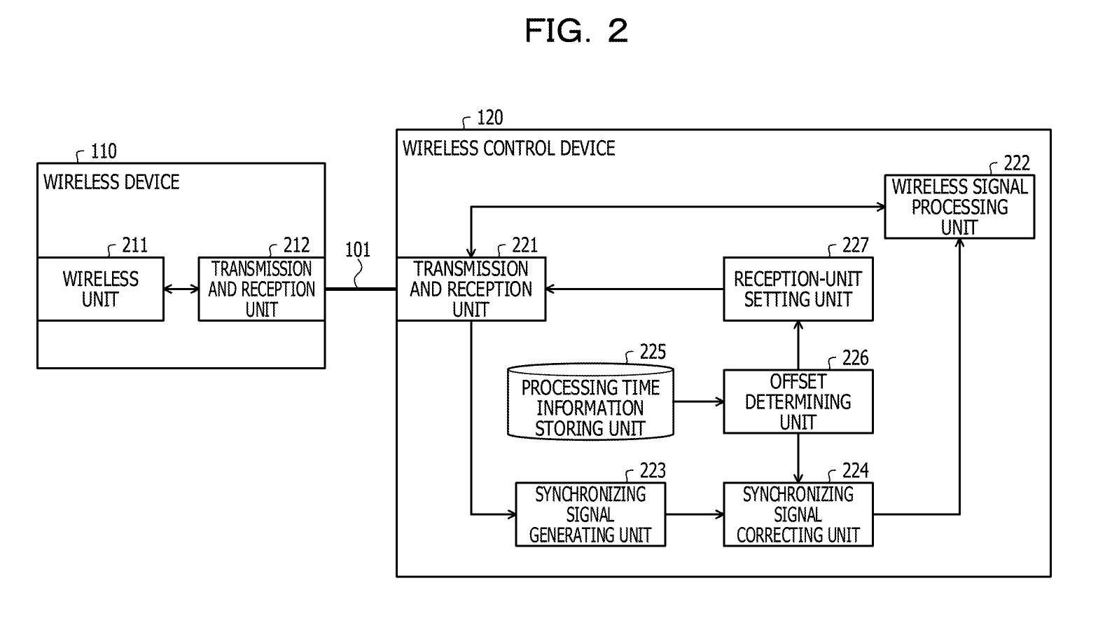

FIG. 2 is a diagram illustrating an exemplary wireless device and an exemplary wireless control device according to the embodiment. In FIG. 2, any part identical to a part illustrated in FIG. 1 is denoted by an identical reference sign, and description thereof will be omitted. As illustrated in FIG. 2, the wireless device 110 includes a wireless unit 211 and a transmission and reception unit 212. The wireless unit 111 illustrated in FIG. 1 may be achieved by, for example, the wireless unit 211. The communication unit 112 illustrated in FIG. 1 may be achieved by, for example, the transmission and reception unit 212.

The wireless unit 211 performs reception processing on a signal wirelessly transmitted from another communication device such as the terminal 130. The reception processing performed by the wireless unit 211 includes, for example, reception through an antenna, amplification by an amplifier, frequency conversion by a mixer, and conversion from an analog signal to a digital signal by an ADC. The ADC stands for analog/digital converter. The wireless unit 211 outputs data (for example, uplink data) obtained through the reception processing to the transmission and reception unit 212.

The wireless unit 211 performs transmission processing on data (for example, downlink data) output from the transmission and reception unit 212. The transmission processing includes, for example, conversion from a digital signal to an analog signal by a DAC, frequency conversion by a mixer, amplification by an amplifier, and wireless transmission through an antenna. The DAC stands for digital/analog converter. The wireless unit 211 wirelessly transmits a signal obtained through the transmission processing to another communication device such as the terminal 130.

The transmission and reception unit 212 formats data output from the wireless unit 211 into the transmission scheme of the transmission path 101, and transmits the formatted data to the wireless control device 120 through the transmission path 101. The transmission and reception unit 212 receives data transmitted from the wireless control device 120 through the transmission path 101. Then, the transmission and reception unit 212 outputs the received data to the wireless unit 211.

The wireless control device 120 includes a transmission and reception unit 221, a wireless signal processing unit 222, a synchronization signal generating unit 223, a synchronization signal correcting unit 224, a processing time information storing unit 225, an offset determining unit 226, and a reception-unit setting unit 227. The communication unit 121 illustrated in FIG. 1 may be achieved by, for example, the transmission and reception unit 221. The control unit 122 illustrated in FIG. 1 may be achieved by, for example, the wireless signal processing unit 222, the synchronization signal generating unit 223, the synchronization signal correcting unit 224, the processing time information storing unit 225, the offset determining unit 226, and the reception-unit setting unit 227.

The transmission and reception unit 221 formats data output from the wireless signal processing unit 222 into the transmission scheme of the transmission path 101, and transmits the formatted data to the wireless device 110 through the transmission path 101. The transmission and reception unit 221 receives data transmitted from the wireless device 110 through the transmission path 101. Then, the transmission and reception unit 221 outputs the received data to the wireless signal processing unit 222 and the synchronization signal generating unit 223.

The transmission and reception unit 221 may divide data output to the wireless signal processing unit 222 in the data size of a unit of reception set by the reception-unit setting unit 227. In other words, at each reception of data in the unit of reception set by the reception-unit setting unit 227 and the transmission and reception unit 221 may output the received data to the wireless signal processing unit 222.

The wireless signal processing unit 222 is triggered by a synchronization signal output from the synchronization signal correcting unit 224 to perform transmission-side wireless signal processing of generating data to be transmitted to the wireless device 110 and outputting the generated data to the transmission and reception unit 221. The wireless signal processing unit 222 is also triggered by a synchronization signal output from the synchronization signal correcting unit 224 to perform reception-side wireless signal processing of decoding data output from the transmission and reception unit 221. Alternatively, when an offset synchronization signal to be described later is output from the synchronization signal correcting unit 224 and the wireless signal processing unit 222 may be triggered by the offset synchronization signal output from the synchronization signal correcting unit 224 to perform the reception-side wireless signal processing.

The synchronization signal generating unit 223 generates a provisional synchronization signal based on a signal output from the transmission and reception unit 221 and outputs the generated synchronization signal to the synchronization signal correcting unit 224. For example, the synchronization signal generating unit 223 counts the number of sampled signals (pieces of data) output from the transmission and reception unit 221. The number of sampled signals is the number of values (symbols) sampled when the transmission and reception unit 221 converts a signal from an analog signal to a digital signal.

Then, the synchronization signal generating unit 223 outputs a pulse signal to the synchronization signal correcting unit 224 each time a result of the counting reaches at a predetermined number, and resets the result of the counting. In this manner, a provisional synchronization signal may be output to the synchronization signal correcting unit 224. The predetermined number is, for example, the number of values sampled in one sub frame (one millisecond).

The synchronization signal correcting unit 224 stores a time when each pulse signal is output from the synchronization signal generating unit 223 as a generation time of the provisional synchronization signal. The time stored in the synchronization signal correcting unit 224 is, for example, an internal time based on a reference clock such as a CPU timer at a computer (for example, a general-purpose server) that achieves the wireless control device 120. The CPU stands for central processing unit. The synchronization signal correcting unit 224 acquires, for example, at a periodic update timing, a predetermined number of past generation times stored up to now. In other words, the synchronization signal correcting unit 224 acquires a predetermined number of latest generation times. The predetermined number is a natural number equal to or larger than two, and is, for example, 100.

Then, the synchronization signal correcting unit 224 predicts a time at which a synchronization signal is generated by the synchronization signal generating unit 223 in the future based on the predetermined number of acquired generation times. This prediction may be performed by, for example, linear prediction. The synchronization-signal generation time in the future predicted by the synchronization signal correcting unit 224 may be the generation time of the next one synchronization signal or the generation times of a plurality of the next synchronization signals. For example, the synchronization signal correcting unit 224 predicts ten generation times in the future based on latest 100 generation times.

Then, the synchronization signal correcting unit 224 outputs a pulse signal to the wireless signal processing unit 222 at the predicted synchronization-signal generation time. In this manner, a synchronization signal obtained by correcting a provisional synchronization signal output from the synchronization signal generating unit 223 may be output to the wireless signal processing unit 222.

As described above, the wireless control device 120 first measures, with the reference clock, the time of a synchronization signal generated by the synchronization signal generating unit 223 and stores a result of the measurement. Then, when a predetermined number of results are stored, the wireless control device 120 estimates a synchronization time in the future based on data of the results through linear prediction, and starts the wireless signal processing with generation of a synchronization signal at the estimated synchronization time.

With this configuration, when the timing of signal transmission from the wireless device 110 to the wireless control device 120 through the transmission path 101 fluctuates, a signal timing with less fluctuation may be calculated to perform wireless signal processing at the wireless signal processing unit 222. This increases a time available for the wireless signal processing at the wireless signal processing unit 222.

In addition, the synchronization signal correcting unit 224 may output a pulse signal to the wireless signal processing unit 222 at a time set to be earlier than the predicted synchronization-signal generation time by an offset of a processing start time notified from the offset determining unit 226. This enables outputting of, to the wireless signal processing unit 222 and an offset synchronization signal that is obtained by correcting a provisional synchronization signal output from the synchronization signal generating unit 223 and is set to be earlier by the offset.

The processing time information storing unit 225 stores, for example, processing time information indicating the processing time (for example, t_FFT_symbol to be described later) of FFT included in the reception-side the wireless signal processing at the wireless signal processing unit 222. The FFT stands for fast Fourier transform.

The offset determining unit 226 determines, based on the processing time information stored in the processing time information storing unit 225 and an offset of a time at which reception processing is to be started at the wireless signal processing unit 222. A method of the offset determination by the offset determining unit 226 will be described later. The offset determining unit 226 notifies the synchronization signal correcting unit 224 of the determined offset.

The offset determining unit 226 determines information (for example, a parameter n to be described later) based on the processing time information stored in the processing time information storing unit 225. Then, the offset determining unit 226 notifies the reception-unit setting unit 227 of the determined information.

The reception-unit setting unit 227 sets a unit of data reception at the transmission and reception unit 221 based on the information (for example, the parameter n to be described later) notified by the offset determining unit 226. The unit of data reception at the transmission and reception unit 221 is, for example, a unit in which the transmission and reception unit 221 outputs data to the wireless signal processing unit 222. Setting of the unit of reception by the reception-unit setting unit 227 will be described later.

In this manner, the wireless control device 120 may change a signal processing trigger and the unit of data reception by shifting the time of a generated synchronization signal. With this configuration, the reception-side the wireless signal processing at the wireless signal processing unit 222 may be started before data reception in a predetermined unit (for example, one sub frame) by the transmission and reception unit 221 is completed. This increases the time available for the wireless signal processing at the wireless signal processing unit 222.

(Wireless Signal Processing Time at Wireless Control Device According to Embodiment)

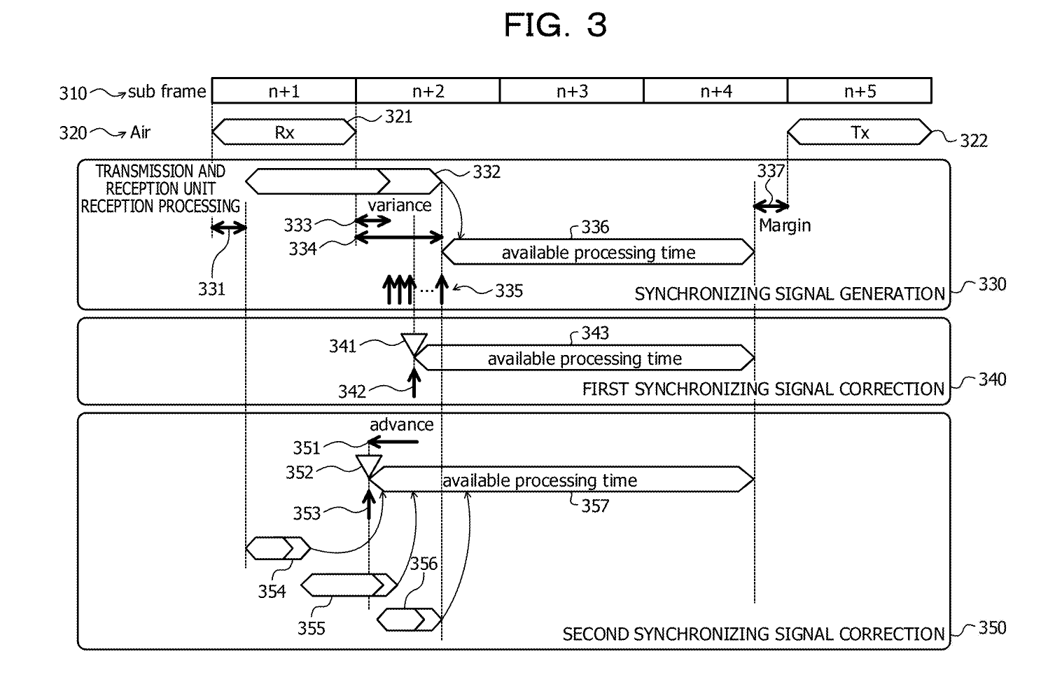

FIG. 3 is a diagram illustrating an exemplary time of wireless signal processing at the wireless control device according to the embodiment. In FIG. 3, the horizontal direction represents time. A sub frame 310 (sub frame) is a sub frame (for example, one millisecond) of wireless communication performed by the wireless control device 120 controlling the wireless device 110. In the example illustrated FIG. 3, the sub frames 310 are five continuous sub frames (n+1) to (n+5).

A wireless signal 320 (Air) is transmitted and received by the wireless control device 120 controlling the wireless device 110. In the example illustrated in FIG. 3, in the sub frame (n+1), the wireless device 110 receives a signal 321 (Rx) wirelessly transmitted from the terminal 130. In the sub frame (n+5) at four sub frames after the sub frame (n+1), the wireless device 110 transmits a signal 322 (Tx) to the terminal 130. The signal 322 includes, for example, a response signal (ACK/NACK) to the signal 321.

Synchronization signal generation 330 represents generation of a synchronization signal by the synchronization signal generating unit 223. The wireless device 110 transmits data acquired from the received signal 321 to the wireless control device 120 through the transmission path 101. A delay time 331 is a time taken for signal processing by the wireless device 110 and data transmission from the wireless device 110 to the wireless control device 120 through the transmission path 101.

Transmission and reception unit reception processing 332 is reception processing in which the transmission and reception unit 221 receives data transmitted from the wireless control device 120 and outputs the received data to the wireless signal processing unit 222 and the synchronization signal generating unit 223. The transmission and reception unit reception processing 332 starts at a timing later than the start of the sub frame (n+1) by the delay time 331.

The end time of the transmission and reception unit reception processing 332 varies due to fluctuation in, for example, task processing at the wireless signal processing unit 222 achieved by software or the like (variance). A minimum delay 333 is the minimum value of delay variance of the end time of the transmission and reception unit reception processing 332. A maximum delay 334 is the maximum value of delay variance of the end time of the transmission and reception unit reception processing 332.

A synchronization signal 335 is a synchronization signal (pulse signal) generated by the synchronization signal generating unit 223 based on data output from the wireless signal processing unit 222. The synchronization signal 335 varies due to variance of the end time of the transmission and reception unit reception processing 332. An available processing time 336 is a time available for the wireless signal processing at the wireless signal processing unit 222 when it is assumed that correction of a synchronization signal by the synchronization signal correcting unit 224 is not performed.

For example, since data transmission and reception between the transmission and reception units 212 and 221 are not synchronized with the timing of a wireless frame (the sub frame 310) and delay varies, fluctuation of the synchronization signal 335 occurs when a synchronization signal is not generated. As a result, the time (available processing time 336) available for the wireless signal processing at the wireless signal processing unit 222 is reduced.

For example, to deal with the variance of the end time of the transmission and reception unit reception processing 332, the available processing time 336 requests to start at the end time of the transmission and reception unit reception processing 332 when the delay of the end time of the transmission and reception unit reception processing 332 reaches at the maximum delay 334. The available processing time 336 ends at a timing earlier than the start time of the sub frame (n+5) by a predetermined margin 337 before transmission of the signal 322 in the sub frame (n+5). A margin 337 is allocated for a time taken for data transmission from the wireless control device 120 to the wireless device 110 through the transmission path 101 and transmission processing at the wireless device 110.

The wireless control device 120 according to the embodiment corrects the generated synchronization signal 335 to increase the time available for the wireless signal processing at the wireless signal processing unit 222. For example, the synchronization signal correcting unit 224 performs first synchronization signal correction 340 illustrated in FIG. 3 on a synchronization signal generated by the synchronization signal generating unit 223. Alternatively, the synchronization signal correcting unit 224 may perform second synchronization signal correction 350 in addition to the first synchronization signal correction 340.

The first synchronization signal correction 340 is correction of the synchronization signal based on prediction of a synchronization-signal generation time by the synchronization signal correcting unit 224. A prediction time 341 is a time at which the synchronization signal 335 is output from the synchronization signal generating unit 223 and that is calculated by the synchronization signal correcting unit 224 through linear prediction based on a synchronization signal output from the synchronization signal generating unit 223 in the past. The prediction time 341 is the average of fluctuation of the synchronization signal 335, and thus is a timing near the center of the width of fluctuation of the synchronization signal 335.

The synchronization signal correcting unit 224 performs, for example, the first synchronization signal correction 340 and outputs a synchronization signal 342 at the prediction time 341 when the second synchronization signal correction 350 is not performed. In this manner, the synchronization signal 342 without fluctuation may be output to the wireless signal processing unit 222.

For example, the synchronization signal correcting unit 224 calculates coefficients a and b of a linear equation y=ax+b through linear prediction. The variable y represents the synchronization-signal generation time. The coefficient a represents the duration (for example, one millisecond) of one sub frame. The variable x represents a sub frame number. The coefficient b represents an offset determined in accordance with a time at which the prediction is started.

For example, the synchronization signal correcting unit 224 calculates the coefficients a and b by Expression (1) below based on the minimum mean square error (MMSE). In Expression (1) below, n represents the number of sampled synchronization-signal generation times used to predict the synchronization-signal generation time. Specifically, the synchronization signal correcting unit 224 calculates the coefficients a and b by using the latest n synchronization-signal generation times and Expression (1) below. In Expression (1) below, xi represents, the sub frame number of the i-th synchronization signal among n synchronization signals. In Expression (1) below, yi represents the i-th synchronization-signal generation time among the n synchronization signals.

$$\begin{matrix}\begin{matrix}a = \frac{n {\sum }_{t = 1}^{n} {x}_{t} {y}_{t} - {\sum }_{t = 1}^{n} {x}_{t} {\sum }_{t = 1}^{n} {y}_{t}}{n {\sum }_{i = 1}^{n} {x}_{t}^{2} - {( {\sum }_{t = 1}^{n} {x}_{t} )}^{2}} \\ = \frac{n {\sum }_{t = 1}^{n} {x}_{t} {y}_{t} - \frac{n ( n + 1 )}{2} {\sum }_{t = 1}^{n} {y}_{t}}{n \frac{( 2 n + 1 ) n ( n + 1 )}{6} - {( \frac{n ( n + 1 )}{2} )}^{2}} \\ = \frac{n {\sum }_{t = 1}^{n} {x}_{t} {y}_{t} - \frac{n ( n + 1 )}{2} {\sum }_{t = 1}^{n} {y}_{t}}{\frac{{n}^{2} ( {n}^{2} + 1 )}{12}}\end{matrix} \\ \begin{matrix}b = \frac{{\sum }_{i = 1}^{n} {x}_{t}^{2} {\sum }_{i = 1}^{n} {y}_{t} - {\sum }_{t = 1}^{n} {x}_{t} {y}_{t} {\sum }_{t = 1}^{n} {x}_{t}}{n {\sum }_{t = 1}^{n} {x}_{t}^{2} - {( {\sum }_{i = 1}^{n} {x}_{t} )}^{2}} \\ = ( \frac{\frac{( 2 n + 1 ) n ( n + 1 )}{6} {\sum }_{t = 1}^{n} {y}_{t} - {\sum }_{t = 1}^{n} {x}_{t} {y}_{t} \frac{n ( n + 1 )}{2}}{n \frac{( 2 n + 1 ) n ( n + 1 )}{6} - {( \frac{n ( n + 1 )}{2} )}^{2}} ) \\ = ( \frac{\frac{( 2 n + 1 ) n ( n + 1 )}{6} {\sum }_{t = 1}^{n} {y}_{t} - {\sum }_{t = 1}^{n} {x}_{t} {y}_{t} \frac{n ( n + 1 )}{2}}{\frac{{n}^{2} ( {n}^{2} + 1 )}{12}} )\end{matrix} \\ {\sum }_{t = 1}^{n} {x}_{i} = {\sum }_{t = 1}^{n} t = \frac{n ( n + 1 )}{2} \\ {\sum }_{i = 1}^{n} {x}_{t}^{2} = {\sum }_{t = 1}^{n} {t}^{2} = \frac{( 2 n + 1 ) n ( n + 1 )}{6}\end{matrix} \} \qquad ( 1 )$$

The synchronization signal correcting unit 224 calculates the prediction time 341 by the linear equation y=ax+b to which the calculated coefficients a and b are applied, and outputs the synchronization signal 342 at the calculated prediction time 341. Alternatively, the synchronization signal correcting unit 224 may update the coefficient b of the linear equation y=ax+b by, for example, periodically calculating the coefficients a and b based on the generation times of the latest synchronization signals. Accordingly, the timing of outputting the synchronization signal 342 is updated. Alternatively, the synchronization signal correcting unit 224 may calculate and update the coefficient b by fixing the coefficient a for the defined duration (for example, one millisecond) of one sub frame.

An available processing time 343 (available processing time) is the time available for the wireless signal processing at the wireless signal processing unit 222 when the synchronization signal correcting unit 224 performs the first synchronization signal correction 340 but not the second synchronization signal correction 350. In such a case, the wireless signal processing unit 222 is triggered by the synchronization signal 342 to start the wireless signal processing. Thus, the available processing time 343 starts at the timing of the synchronization signal 342. The end time of the available processing time 343 is same as the end time of the available processing time 336.

In this manner, the synchronization signal correcting unit 224 generates the synchronization signal 342 without fluctuation based on synchronization signals generated by the synchronization signal generating unit 223 in the past, thereby increasing the time available for the wireless signal processing at the wireless signal processing unit 222.

The second synchronization signal correction 350 is correction of a synchronization signal by the synchronization signal correcting unit 224 based on an offset determined by the offset determining unit 226. The synchronization signal correcting unit 224 calculates a correction time 352 earlier than the prediction time 341 by an offset 351 (advance) calculated based on the offset notified by the offset determining unit 226. Then, the synchronization signal correcting unit 224 outputs an offset synchronization signal 353 at the correction time 352. In this manner, the offset synchronization signal 353 earlier than the synchronization signal 342 without fluctuation by the offset 351 is output to the wireless signal processing unit 222.

The reception-unit setting unit 227 sets the unit of reception processing at the transmission and reception unit 221 based on the information determined by the offset determining unit 226. In the example illustrated in FIG. 3, the reception-unit setting unit 227 sets the unit of reception processing at the transmission and reception unit 221 such that the transmission and reception unit reception processing 332 for one sub frame is divided into transmission and reception unit reception processing 354 to 356. The transmission and reception unit 221 controls buffering of data output to the wireless signal processing unit 222 through the unit of reception set by the reception-unit setting unit 227.

For example, when the transmission and reception unit reception processing 354 ends, the transmission and reception unit 221 outputs data obtained through the transmission and reception unit reception processing 354 to the wireless signal processing unit 222 to start transmission and reception unit reception processing 355. When the transmission and reception unit reception processing 355 ends, the transmission and reception unit 221 outputs data obtained through the transmission and reception unit reception processing 355 to the wireless signal processing unit 222 to start transmission and reception unit reception processing 356. When the transmission and reception unit reception processing 356 ends, the transmission and reception unit 221 outputs data obtained through the transmission and reception unit reception processing 356 to the wireless signal processing unit 222.

An available processing time 357 (available processing time) is the time available for the wireless signal processing at the wireless signal processing unit 222 when the synchronization signal correcting unit 224 performs the first synchronization signal correction 340 and the second synchronization signal correction 350. In other words, when the synchronization signal correcting unit 224 performs the first synchronization signal correction 340 and the second synchronization signal correction 350, the wireless signal processing unit 222 is triggered by the offset synchronization signal 353 to start the wireless signal processing. Thus, the available processing time 357 starts at the timing of the offset synchronization signal 353. The end time of the available processing time 357 is same as the end time of the available processing time 336.

The start time of the available processing time 357 is in a time in which the wireless signal processing unit 222 performs the transmission and reception unit reception processing 355. In other words, the wireless signal processing unit 222 may start the wireless signal processing before the transmission and reception unit 221 completes reception processing of one sub frame.

In this manner, the second synchronization signal correction 350 may increase the available processing time 357 by exploiting a difference between a time at which reception data is requested in the wireless signal processing at the wireless signal processing unit 222 and a time at which the data actually arrives at the wireless signal processing unit 222. In this case, the reception-unit setting unit 227 controls the unit of reception by the transmission and reception unit 221 so that the data requested by the wireless signal processing is already received.

(Wireless Signal Processing Unit According to the Embodiment)

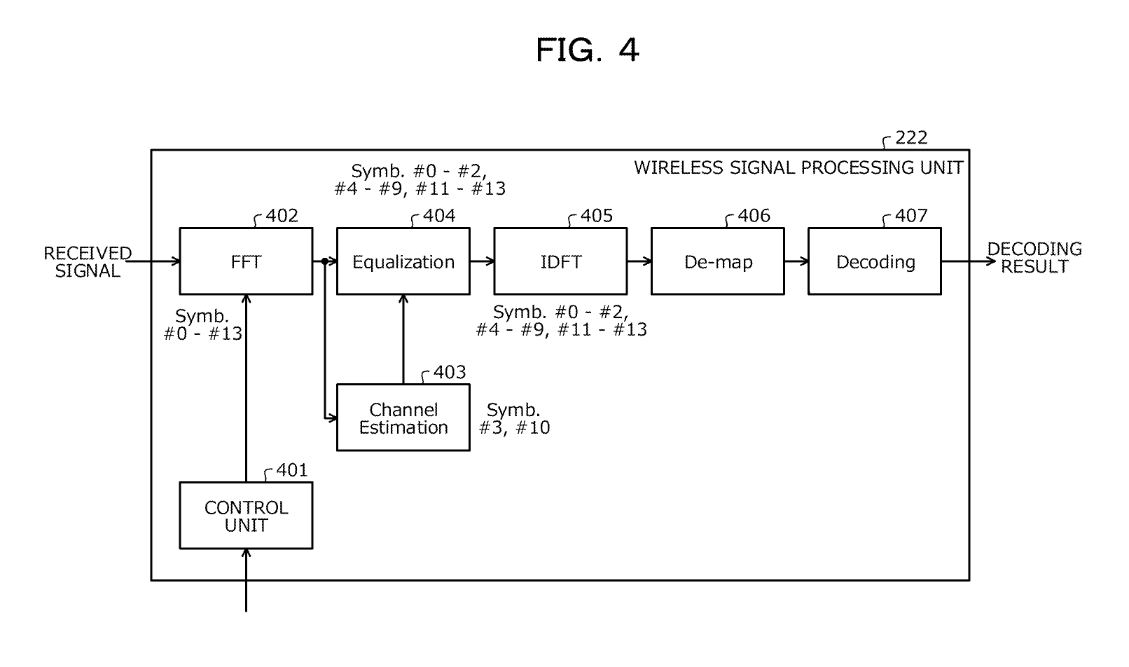

FIG. 4 is a diagram illustrating an exemplary wireless signal processing unit according to the embodiment. The following describes the processing unit for the reception-side wireless signal processing among the processing units of the wireless signal processing unit 222 illustrated in FIG. 2. In the example illustrated in FIG. 4, the base station 100 receives an uplink signal from the terminal 130 in LTE. In the example illustrated in FIG. 4, retransmission control by Hybrid Automatic Repeat reQuest (HARQ) is performed. In the HARQ, a response signal (ACK/NACK) to a transmitted signal requests to be transmitted back in four sub frames.

The wireless signal processing unit 222 includes, as processing units for the reception-side wireless signal processing, for example, a control unit 401, a FFT unit 402 (“FFT”), and a channel estimating unit 403 (“Channel Estimation”) as illustrated in FIG. 4. The wireless signal processing unit 222 also includes, as processing units for the wireless signal processing, for example, an equalization unit 404 (“Equalization”), an IDFT unit 405 (“IDFT”), a de-mapping unit 406 (“De-map”), and a decoding unit 407 (“Decoding”). The IDFT stands for inverse discrete Fourier transform.

For example, when the synchronization signal correcting unit 224 performs the first synchronization signal correction 340 described above but does not perform the second synchronization signal correction 350 described above, a synchronization signal is input to the control unit 401 from the synchronization signal correcting unit 224. In such a case, the control unit 401 is triggered by the timing of the input synchronization signal to perform control of starting FFT at the FFT unit 402.

When the synchronization signal correcting unit 224 performs the first synchronization signal correction 340 and the second synchronization signal correction 350 described above, an offset synchronization signal is input to the control unit 401 from the synchronization signal correcting unit 224. In such a case, the control unit 401 is triggered by the timing of the input offset synchronization signal to perform control of starting FFT at the FFT unit 402.

A received signal (data) output from the transmission and reception unit 221 is input to the FFT unit 402. For example, a LTE sub frame is composed of 14 symbols when normal cyclic prefixes (CP) are used. The fourth symbol and the eleventh symbol of an uplink signal transmitted from the terminal 130 to the base station 100 store demodulation reference signals (RS).

Under control of the control unit 401, the FFT unit 402 performs FFT on the input received signal. For example, the FFT unit 402 performs FFT on 14 symbols (Symb. #0 to #13) in the input received signal for one sub frame. Accordingly, the received signal output from the transmission and reception unit 221 is converted from the time domain to the frequency domain. FFT may be performed, for example, in units of symbols. The FFT unit 402 outputs the received signal on which FFT is performed to the channel estimating unit 403 and the equalization unit 404.

The channel estimating unit 403 performs channel estimation (propagation path estimation) based on the received signal output from the FFT unit 402. The channel estimation is, for example, estimation of impulse response through a propagation path. For example, the channel estimating unit 403 performs the channel estimation based on the reference signals stored in the fourth symbol and the eleventh symbol (Symb. #3 and #10) in the received signal output from the FFT unit 402.

Thus, execution of the channel estimation by the channel estimating unit 403 requests FFT to be performed up to the eleventh symbol by the FFT unit 402. The channel estimating unit 403 outputs a result of the channel estimation to the equalization unit 404.

The equalization unit 404 performs equalization processing (for example, adaptive equalization processing) on the received signal output from the FFT unit 402 based on the result of the channel estimation output from the channel estimating unit 403. The equalization processing performed by the equalization unit 404 is, for example, adaptive equalization processing of adaptively performing the equalization processing. For example, the equalization unit 404 performs the equalization processing on symbols (Symb. #0 to #2, #4 to #9, and #11 to #13) except for the fourth symbol and the eleventh symbol in the received signal output from the FFT unit 402. the equalization unit 404 outputs the symbols on which the equalization processing is performed to the IDFT unit 405.

Execution of the channel estimation by the channel estimating unit 403 as described above requests FFT to be performed up to the eleventh symbol by the FFT unit 402. Thus, until FFT is performed up to the eleventh symbol by the FFT unit 402, the result of the channel estimation is not output from the channel estimating unit 403 to the equalization unit 404, and the equalization processing by the equalization unit 404 is not performed.

The IDFT unit 405 performs IDFT on the received signal output from the equalization unit 404. For example, the IDFT unit 405 performs the IDFT on the symbols (Symb. #0 to #2, #4 to #9, and #11 to #13) output from the equalization unit 404. Then, the IDFT unit 405 outputs the symbols on which the IDFT is performed to the de-mapping unit 406. The de-mapping unit 406 performs de-mapping on the symbols output from the IDFT unit 405. Then, the de-mapping unit 406 outputs the symbols on which the de-mapping is performed to the decoding unit 407.

The processing from the processing by the FFT unit 402 to the processing by the de-mapping unit 406 may be executed in units of symbols before arrival of all pieces of data (symbols) for one sub frame. However, the channel estimation by the channel estimating unit 403 is performed after arrival of the eleventh symbol. Then, the equalization processing by the equalization unit 404 is performed after arrival of a result of the channel estimation by the channel estimating unit 403.

The decoding unit 407 decodes the symbols output from the de-mapping unit 406 and outputs data (decoding result) obtained by the decoding. The decoding by the decoding unit 407 is performed, for example, in units of sub frames. Specifically, the decoding unit 407 performs the decoding after outputting of symbols for one sub frame from the de-mapping unit 406. The data output from the decoding unit 407 is processed by, for example, a higher-level processing unit at the base station 100.

The decoding by the decoding unit 407 includes error detection. The wireless control device 120 generates a response signal (ACK/NACK) indicating a result of the error detection by the decoding unit 407 and outputs the response signal to the wireless device 110. For example, a response signal (ACK/NACK) indicating a result of the error detection on the signal 321 illustrated in FIG. 3 by the decoding unit 407 is stored in the signal 322 to the terminal 130 illustrated in FIG. 3.

(Second Synchronization Signal Correction at Wireless Control Device According to the Embodiment)

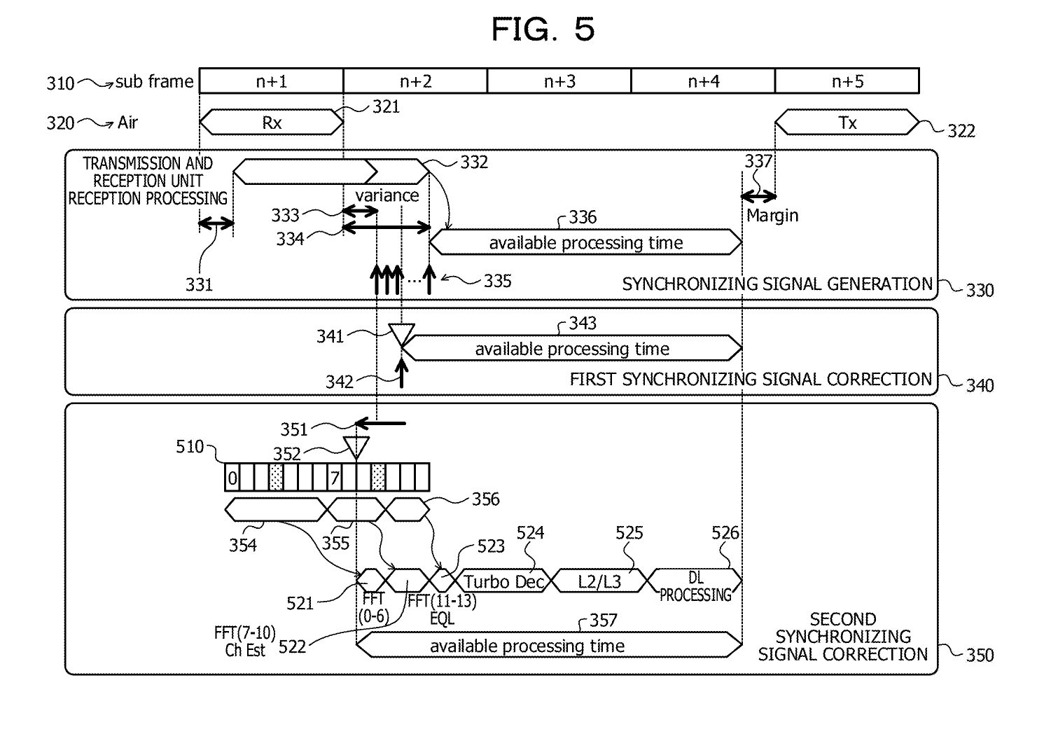

FIG. 5 is a diagram illustrating exemplary second synchronization signal correction at the wireless control device according to the embodiment. In FIG. 5, any part identical to a part illustrated in FIG. 3 is denoted by an identical reference sign, and description thereof will be omitted. A sub frame 510 in the second synchronization signal correction 350 illustrated in FIG. 5 is a sub frame of data received from the wireless device 110 by the transmission and reception unit 221.

In the example illustrated in FIG. 5, the sub frame 510 is a sub frame received by the transmission and reception unit 221 when the delay of the end time of the transmission and reception unit reception processing 332 reaches at the maximum delay 334. The sub frame 510 includes 14 symbols indexed by 0 to 13. The fourth and eleventh symbols of the sub frame 510 store reference signals.

For example, the reception-unit setting unit 227 sets the transmission and reception unit 221 receive data for one sub frame in a divided manner in three sets of data of seven symbols, four symbols, and three symbols and output the data to the wireless signal processing unit 222. In such a case, the transmission and reception unit 221 performs the transmission and reception unit reception processing 354 on the data of the seven symbols, the transmission and reception unit reception processing 355 on the data of the four symbols, and the transmission and reception unit reception processing 356 on the data of the three symbols.

Wireless signal processing 521 to 526 is wireless signal processing at the wireless signal processing unit 222. The wireless signal processing 521 is started at the correction time 352. The wireless signal processing 521 to 524 is, for example, Layer 1 reception processing by the wireless signal processing unit 222.

The wireless signal processing 521 includes FFT (FFT (0-6)), by the FFT unit 402, on the first to seventh symbols of the sub frame obtained through the transmission and reception unit reception processing 354.

The wireless signal processing 522 is performed right after the wireless signal processing 521. The wireless signal processing 522 includes FFT (FFT (7-10)), by the FFT unit 402, on the eighth to eleventh symbols of the sub frame obtained through the transmission and reception unit reception processing 355. The wireless signal processing 522 includes the channel estimation by the channel estimating unit 403 (Ch Est) based on the fourth and eleventh symbols of the sub frame obtained through the transmission and reception unit reception processing 354 and 355.

The wireless signal processing 523 is performed right after the wireless signal processing 522. The wireless signal processing 523 includes FFT (FFT (11-13)), by the FFT unit 402, on the twelfth to fourteenth symbols of the sub frame obtained through the transmission and reception unit reception processing 356. The wireless signal processing 523 includes equalization processing (EQL), by the equalization unit 404, on 12 symbols except for the reference signals among the 14 symbols on which the FFT is performed through the wireless signal processing 521 to 523. The equalization processing is performed based on a result of the channel estimation through the wireless signal processing 522.

The wireless signal processing 524 is performed right after the wireless signal processing 523. The wireless signal processing 524 includes, for example, turbo decoding (Turbo Dec), by the decoding unit 407, on each symbol on which the equalization processing is performed by the wireless signal processing 523. The wireless signal processing 524 may include the IDFT by the IDFT unit 405 and the de-mapping by the de-mapping unit 406 described above.

The wireless signal processing 525 (L2/L3) is performed right after the wireless signal processing 524. The wireless signal processing 525 includes Layer 2 and Layer 3 reception processing based on data obtained through the wireless signal processing 524. The wireless signal processing 525 also includes Layer 3 and Layer 2 transmission processing on a signal transmitted from the base station 100 to the terminal 130. The signal transmitted from the base station 100 to the terminal 130 includes, for example, a response signal (ACK/NACK) to the data obtained through the wireless signal processing 524.

The wireless signal processing 526 (DL processing) is performed right after the wireless signal processing 525. The wireless signal processing 526 includes Layer 1 transmission processing, by the wireless signal processing unit 222, on downlink data obtained through the wireless signal processing 525. The Layer 1 transmission processing includes processing such as encoding, mapping, and inverse fast Fourier transform (IFFT). The wireless signal processing unit 222 outputs data obtained through the wireless signal processing 526 to the transmission and reception unit 221.

As illustrated in FIG. 5, the first synchronization signal correction 340 reduces fluctuation of a synchronization signal generated by the synchronization signal generating unit 223, and in addition, the second synchronization signal correction 350 allows wireless signal processing to be started at an earlier time by an offset time obtained through linear prediction.

For example, at the correction time 352 based on the offset 351 in the example illustrated in FIG. 5, the reception processing by the transmission and reception unit 221 is completed up to the seventh symbol when the wireless signal processing 521 is started. Thus, FFT is executable on the first to seventh symbols at the correction time 352.

Then, when the execution of FFT is completed on the first to seventh symbols, the reception processing by the transmission and reception unit 221 is completed on the eighth to eleventh symbols. Thereafter, in the wireless signal processing 523, the wireless signal processing unit 222 performs FFT on the ninth to eleventh symbols, and then executes the channel estimation. Reception of data of one sub frame is already completed when the wireless signal processing 523 is completed, and thus the subsequent processing may be continued irrespective of a reception condition.

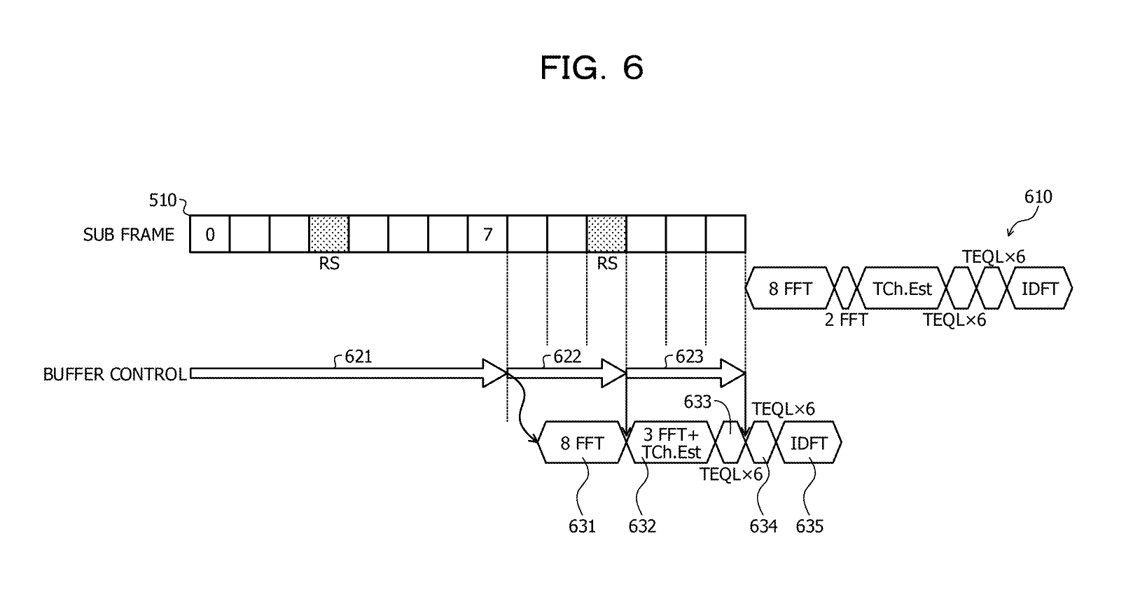

FIG. 6 is a diagram illustrating exemplary setting of the start time of wireless signal processing at the wireless control device according to the embodiment. In FIG. 6, any part identical to a part illustrated in FIG. 5 is denoted by an identical reference sign, and description thereof will be omitted.

Wireless signal processing 610 is wireless signal processing at the wireless signal processing unit 222 when it is assumed that, after having received all data for the sub frame 510, the transmission and reception unit 221 outputs the data to the wireless signal processing unit 222. In this case, the wireless signal processing 610 may not be started until reception for the sub frame 510 is completed, which reduces a time available for the wireless signal processing 610.

In FIG. 6, a first unit of reception 621, a second unit of reception 622, and a third unit of reception 623 are exemplary units of reception set to the transmission and reception unit 221 by the reception-unit setting unit 227. The wireless unit 211 performs buffer control on data output to the wireless signal processing unit 222 in the unit of reception set by the reception-unit setting unit 227.

In the example illustrated in FIG. 6, the first unit of reception 621 is eight symbols, the second unit of reception 622 is three symbols, and the third unit of reception 623 is three symbols. In such a case, when having received the first to eighth symbols corresponding to the first unit of reception 621 in the sub frame 510, the transmission and reception unit 221 outputs the first to eighth symbols to the wireless signal processing unit 222.

Subsequently, when having received the ninth to eleventh symbols corresponding to the second unit of reception 622 in the sub frame 510, the transmission and reception unit 221 outputs the ninth to eleventh symbols to the wireless signal processing unit 222. Subsequently, when having received the twelfth to fourteenth symbols corresponding to the third unit of reception 623 in the sub frame 510, the transmission and reception unit 221 outputs the twelfth to fourteenth symbols to the wireless signal processing unit 222.

Wireless signal processing 631 to 635 is the reception-side wireless signal processing at the wireless signal processing unit 222. The wireless signal processing 631 is started after data (the first to eighth symbols) of the first unit of reception 621 is output from the transmission and reception unit 221. The wireless signal processing 631 includes FFT (8 FFT) on the first to eighth symbols in the sub frame 510 by the FFT unit 402.

The wireless signal processing 632 is performed right after the wireless signal processing 631. The wireless signal processing 632 includes FFT (3 FFT) on the ninth to eleventh symbols in the sub frame 510 by the FFT unit 402. The wireless signal processing 632 includes the channel estimation (TCh. Est) based on the reference signals stored in the fourth and eleventh symbols in the sub frame 510.

The wireless signal processing 633 is performed right after the wireless signal processing 632. The wireless signal processing 633 includes equalization processing (TEQL×6) on six symbols except for the reference signal in the fourth symbol among the first to seventh symbols in the sub frame 510 by the equalization unit 404 based on a result of the channel estimation included in the wireless signal processing 632.

The wireless signal processing 634 is performed right after the wireless signal processing 633. The wireless signal processing 634 includes equalization processing (TEQL×6) on six symbols except for the reference signal in the eleventh symbol among the eighth to fourteenth symbols in the sub frame 510 by the equalization unit 404 based on a result of the channel estimation included in the wireless signal processing 632.

The wireless signal processing 635 is performed right after the wireless signal processing 634. The wireless signal processing 635 includes IDFT on 12 symbols except for the fourth and eleventh symbols in the sub frame 510 by the IDFT unit 405.

As described above, the channel estimation by the wireless signal processing unit 222 may not be started until the eleventh symbol is received, and processing after the equalization processing by the wireless signal processing unit 222 may not be started until the channel estimation is completed. The FFT by the wireless signal processing unit 222 is processing performed at the previous stage of the channel estimation, and thus may be performed at reception of each symbol.

Thus, the unit of reception is divided, for example, when the second reference signal (the eleventh symbol) is received. In other words, when FFT processing executable before reception of the second reference signal is completed before reception of the second reference signal, the subsequent processing may be completed early.

For example, t_FFT_symbol represents a time taken for FFT for one symbol, and t_symbol represents the duration (70 μs approximately) of one symbol. With this notation, most efficient processing is possible, for example, when the relation n*(t_symbol+t_FFT_symbol)=11*t_symbol is satisfied.

Thus, the offset determining unit 226 calculates n that satisfies Expression (2) below. The first unit of reception 621 is set to n symbols, the second unit of reception 622 is set to (11−n) symbols, and the third unit of reception 623 is set to three symbols. FIG. 6 illustrates a case with n=8, and in this case, the first unit of reception 621 is eight symbols, the second unit of reception 622 is eight symbols, and the third unit of reception 623 is three symbols as described above.

$$n = 11 ⌊ \frac{t\_symbol}{t\_symbol + t\_FFT \_symbol} ⌋ \qquad ( 2 )$$

Accordingly, the wireless signal processing unit 222 may start the wireless signal processing, for example, when reception of nine symbols approximately is completed. In this case, a processing time longer by five symbols approximately may be provided as compared to a case in which the wireless signal processing is started after reception of the sub frame is completed. For example, in the case in which the wireless signal processing is started after reception of the sub frame is completed, the time available for the wireless signal processing is 37 symbols approximately. In the case in which the wireless signal processing is started when reception of nine symbols approximately is completed, the time available for the wireless signal processing is 14*3=42 symbols in an ideal case. Thus, the time available for the wireless signal processing may be improved by 13.5% approximately.

For example, the processing time information storing unit 225 stores the time t_FFT_symbol taken for FFT for one symbol and the duration t_symbol of one symbol. Then, the offset determining unit 226 calculates the parameter n based on the time t_FFT_symbol and the duration t_symbol stored in the processing time information storing unit 225. Then, the offset determining unit 226 notifies the reception-unit setting unit 227 of the calculated parameter n.

The offset determining unit 226 calculates the offset 351 based on the calculated parameter n. For example, the offset determining unit 226 calculates the offset 351 by 3*t_symbol+n*t_FFT_symbol. Then, the offset determining unit 226 notifies the synchronization signal correcting unit 224 of the calculated offset 351. Accordingly, the wireless signal processing may be started earlier by the sum of a duration between the end time of the sub frame and reception of the second reference signal and the processing time of FFT executable before reception of the second reference signal is completed.

The reception-unit setting unit 227 sets, to the transmission and reception unit 221, the first unit of reception 621 (n symbols), the second unit of reception 622 ((11−n) symbols), and the third unit of reception 623 (three symbols) based on the parameter n notified by the offset determining unit 226.

The parameter n, the offset 351, the first unit of reception 621, the second unit of reception 622, and the third unit of reception 623 are determined based on the time t_FFT_symbol and the duration t_symbol. The time t_FFT_symbol is determined based on the processing capacity of the wireless control device 120, and the duration t_symbol is defined in wireless communication system.

Thus, this information may be calculated in advance and stored in a memory. For example, a memory of the wireless control device 120 may store the offset 351, the first unit of reception 621, the second unit of reception 622, and the third unit of reception 623 calculated based on the time t_FFT_symbol and the duration t_symbol.

In this case, the synchronization signal correcting unit 224 performs the second synchronization signal correction 350 described above by using the offset 351 stored in the memory of the wireless control device 120. The reception-unit setting unit 227 sets the unit of reception at the wireless unit 211 based on the first unit of reception 621, the second unit of reception 622, and the third unit of reception 623 stored in the memory of the wireless control device 120. In this case, the processing time information storing unit 225 and the offset determining unit 226 illustrated in FIG. 2 may be removed from the configuration.

(Prediction of Synchronization-Signal Generation Time According to the Embodiment)

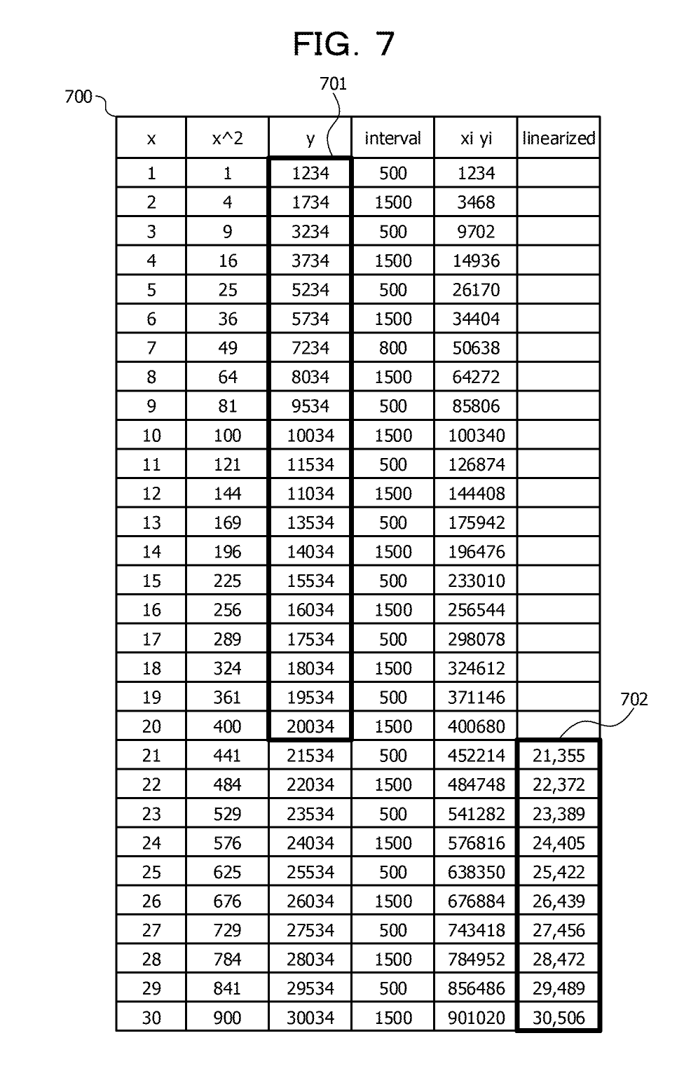

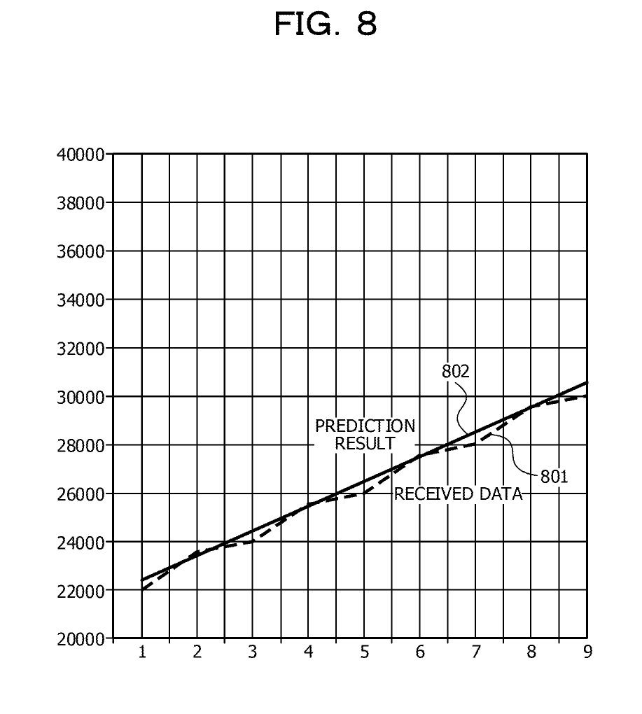

FIGS. 7 and 8 are each a diagram illustrating exemplary prediction of a synchronization-signal generation time according to the embodiment. In a table 700 illustrated in FIG. 7, the item “x” represents the number of sub frames (samples). In the table 700, the item “y” represents a time at which a synchronization signal is generated by the synchronization signal generating unit 223. In the table 700, the item “interval” represents a time interval from a time at which the corresponding synchronization signal is generated to a time at which the next synchronization signal is generated.

Time data 701 is the generation times of synchronization signals of the latest 20 samples among times at which the synchronization signal generating unit 223 generated synchronization signals, at a timing at which the synchronization signal correcting unit 224 updates the coefficient b of the linear equation y=ax+b. In the example illustrated in FIG. 7, the time data 701 includes a time at which a synchronization signal for each x=1 to 20 is generated.

For example, the synchronization signal correcting unit 224 predicts the generation times of synchronization signals of 10 samples in the future based on the time data 701 of 20 samples. In the example illustrated in FIG. 7, the synchronization signal correcting unit 224 predicts times at which the synchronization signals of x=21 to 30 are generated by the synchronization signal generating unit 223.

In the example illustrated in FIG. 7, the synchronization signal correcting unit 224 calculates the coefficient a=1016.767 and the coefficient b=2.947 by substituting n=20 in Expression (1) above. Then, the synchronization signal correcting unit 224 predicts, by using the calculated coefficients a and b and y=ax+b, times at which the synchronization signals of x=21 to 30 are generated by the synchronization signal generating unit 223. A linearized prediction result 702 of the time data 701 is the synchronization-signal generation times of x=21 to 30 predicted by the synchronization signal correcting unit 224 by using the calculated coefficients a and b and y=ax+b. For example, the synchronization signal correcting unit 224 predicts that the synchronization signal of x=21 following x=20 is generated at time=21355.

Thus, the synchronization signal correcting unit 224 outputs a synchronization signal to the wireless signal processing unit 222 at each time indicated by the prediction result 702. The synchronization signal correcting unit 224 also outputs an offset synchronization signal to the wireless signal processing unit 222 at a time earlier than each time indicated by the prediction result 702 by the offset 351 described above.

In FIG. 8, the horizontal axis represents x (sub frame number), and the vertical axis represents time. Reception data 801 indicates times at which, among the synchronization signals of x≡1 to 20, the synchronization signals of x≡1 to 10 are output from the synchronization signal generating unit 223. A prediction result 802 indicates a result of linear approximation (y=ax+b) based on the coefficients a and b calculated based on times at which the synchronization signals of x≡1 to 20 are output from the synchronization signal generating unit 223.

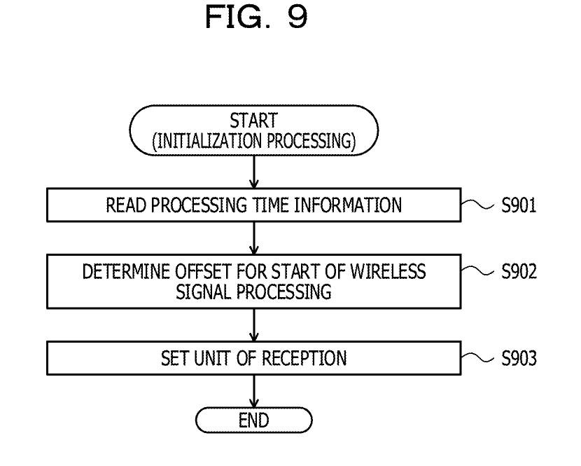

FIG. 9 is a flowchart of exemplary initialization processing by the wireless control device according to the embodiment. The wireless control device 120 according to the embodiment executes, as initialization processing at activation, for example, steps illustrated in FIG. 9.

First, the offset determining unit 226 of the wireless control device 120 reads the processing time information stored in the processing time information storing unit 225 (step S901). Subsequently, the offset determining unit 226 of the wireless control device 120 determines the offset 351 for the start of the wireless signal processing based on the processing time information read at step S901 (step S902).

Subsequently, the reception-unit setting unit 227 of the wireless control device 120 sets, to the transmission and reception unit 221, the unit of reception calculated based on the processing time information read at step S901 (step S903), and ends this series of initialization processing.

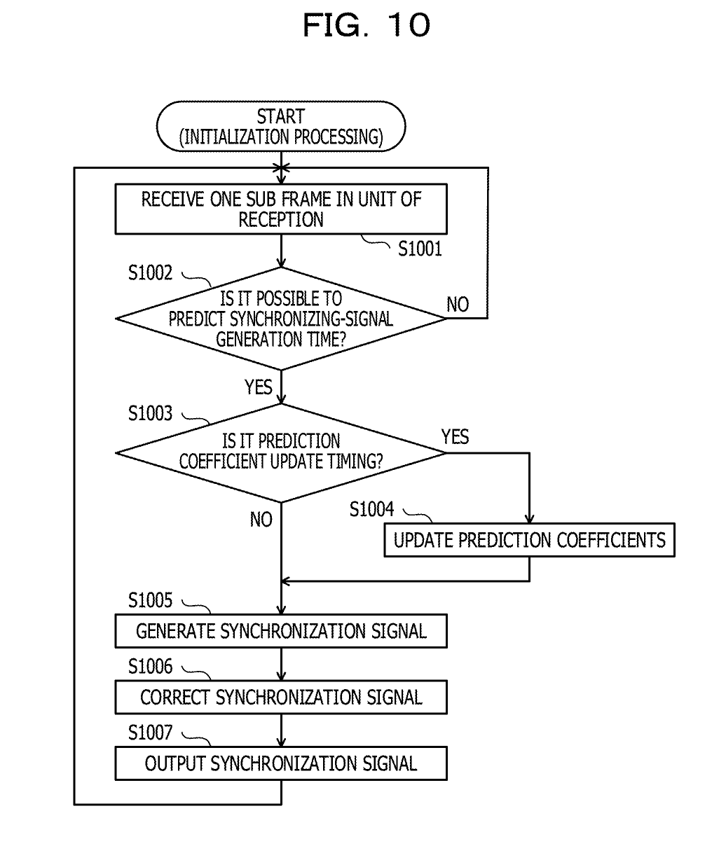

FIG. 10 is a flowchart illustrating exemplary synchronization processing by the wireless control device according to the embodiment. The wireless control device 120 according to the embodiment executes, for example, steps illustrated in FIG. 10 as synchronization processing after the initialization processing illustrated in FIG. 9.

First, the transmission and reception unit 221 of the wireless control device 120 receives one sub frame in the unit of reception set at step S903 in FIG. 9 (step S1001). Subsequently, the synchronization signal correcting unit 224 of the wireless control device 120 determines whether a number of samples (reception data) requested for predicting a time at which a synchronization signal is generated by the synchronization signal generating unit 223 in the future are stored as a result of the reception of a sub frame at step S1001 (step S1002).

At step S1002, if the number of samples for predicting the synchronization-signal generation time are not stored (No at step S1002), the synchronization signal correcting unit 224 of the wireless control device 120 returns to step S1001. If the number of samples for predicting the synchronization-signal generation time are stored (Yes at step S1002), the synchronization signal correcting unit 224 of the wireless control device 120 determines whether it is a prediction coefficient update timing (step S1003). The prediction coefficient update timing is, for example, a periodic timing.

At step S1003, if it is not the prediction coefficient update timing (No at step S1003), the synchronization signal correcting unit 224 of the wireless control device 120 proceeds to step S1005. If it is the prediction coefficient update timing (Yes at step S1003), the synchronization signal correcting unit 224 of the wireless control device 120 updates prediction coefficients based on Expression (1) above and the generation times of latest synchronization signals by the synchronization signal generating unit 223 (step S1004). The prediction coefficients are the coefficients a and b (or the coefficient b only) of the linear equation y=ax+b described above.

Subsequently, the synchronization signal generating unit 223 of the wireless control device 120 generates a synchronization signal indicating that reception for one sub frame is completed at step S1001 (step S1005). Subsequently, the synchronization signal correcting unit 224 of the wireless control device 120 corrects the synchronization signal generated at step S1005 (step S1006). For example, the synchronization signal correcting unit 224 calculates a prediction time based on the latest coefficients a and b updated at step S1004 and y=ax+b.

Subsequently, the synchronization signal correcting unit 224 of the wireless control device 120 outputs the synchronization signal corrected at step S1006 to the wireless signal processing unit 222 (step S1007), and returns to step S1001. At step S1007, the synchronization signal correcting unit 224 outputs the corrected synchronization signal by, for example, outputting a pulse signal at the prediction time calculated at step S1006.

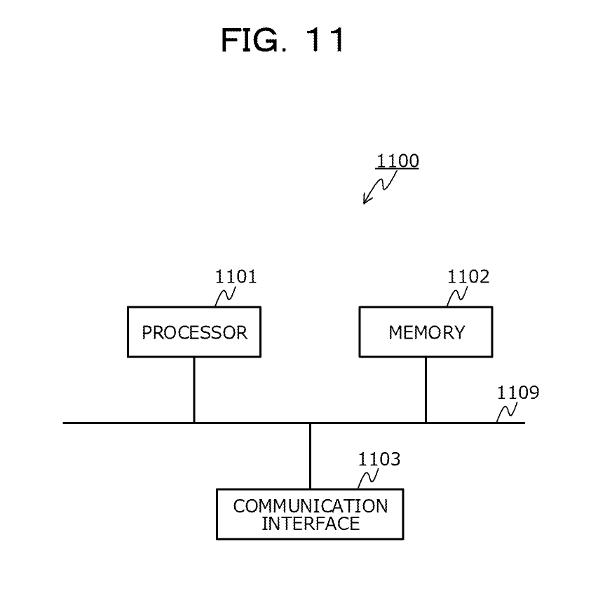

FIG. 11 is a diagram illustrating an exemplary hardware configuration of the wireless control device according to the embodiment. The wireless control device 120 illustrated in FIG. 2 may be achieved by, for example, an information processing device 1100 illustrated in FIG. 11. The information processing device 1100 is a general-purpose computer such as a general-purpose server. The information processing device 1100 includes a processor 1101, a memory 1102, and a communication interface 1103. The processor 1101, the memory 1102, and the communication interface 1103 are connected with each other through, for example, a bus 1109.

The processor 1101 is a circuit configured to perform signal processing and is, for example, a CPU configured to govern control of the entire information processing device 1100. The memory 1102 includes, for example, a main memory and an auxiliary memory. The main memory is, for example, a random access memory (RAM). The main memory is used as a work area of the processor 1101. The auxiliary memory is, for example, a non-transitory memory such as a magnetic disk, an optical disk, or a flash memory. The auxiliary memory stores various computer programs that operate the information processing device 1100. The computer programs stored in the auxiliary memory are loaded onto the main memory and executed by the processor 1101.

The communication interface 1103 includes a communication interface (for example, an Ethernet communication interface) configured to perform signal transmission with the wireless device 110 through the transmission path 101. The communication interface 1103 may include a communication interface configured to perform signal transmission with a higher-level device of the base station 100. The communication interface 1103 is controlled by the processor 1101.

The communication unit 121 of the wireless control device 120 illustrated in FIG. 1 is achieved by, for example, the communication interface 1103. The control unit 122 of the wireless control device 120 illustrated in FIG. 1 is achieved by, for example, the processor 1101.

The wireless unit 111 of the wireless device 110 illustrated in FIG. 1 is achieved by, for example, a circuit such as an antenna, an amplifier, a mixer, or an ADC. The wireless unit 111 of the wireless device 110 illustrated in FIG. 1 may be achieved by a communication interface (for example, an Ethernet communication interface) configured to perform signal transmission with the communication interface 1103 of the information processing device 1100 through the transmission path 101.

With this configuration, the wireless control device 120 according to the embodiment stores a time at each reception of a predetermined amount of signal from the wireless device 110 and performs the wireless signal processing based on a time calculated based on a plurality of stored times. Accordingly, when the timing of signal transmission from the wireless device 110 to the wireless control device 120 through the transmission path 101 fluctuates, a signal timing without the fluctuation may be calculated to perform the wireless signal processing. This increases a time available for the wireless signal processing at the wireless control device 120.

The wireless control device 120 according to the embodiment may calculate a time at which a predetermined amount of signal is received from the wireless device 110 based on a plurality of stored times, and start the signal decoding processing at a time earlier than the calculated prediction time. This increases the time available for the wireless signal processing on a received signal at the base station 100.

The increased time available for the wireless signal processing at the wireless control device 120 allows defined wireless communication to be achieved, for example, when hardware that performs the wireless signal processing at the wireless control device 120 has low processing performance. Thus, reduction may be achieved in, for example, the number of cores of a CPU that performs the wireless signal processing at the wireless control device 120 and the clock rate of the CPU. Accordingly, reduction may be achieved in, for example, a manufacturing cost and power consumption.

The embodiment describes above the configuration in which a provisional synchronization signal is generated by the synchronization signal generating unit 223 and corrected by the synchronization signal correcting unit 224 based on a time at which the provisional synchronization signal is generated by the synchronization signal generating unit 223, thereby generating a synchronization signal, but the present embodiment is not limited to this configuration. For example, without generating a provisional synchronization signal, the synchronization signal generating unit 223 may notify the synchronization signal correcting unit 224 of a time at which a result of counting the number of sampled signals that have been output from the transmission and reception unit 221 reaches at a predetermined number. In this case, the synchronization signal correcting unit 224 generates a synchronization signal based on the time notified by the synchronization signal generating unit 223.

According to the wireless control device, the wireless device, and the processing method as described above, the time available for the wireless signal processing at the wireless control device may be increased when the time of signal transmission from the wireless device to the wireless control device fluctuates.

For example, recently, LTE has been introduced as a fourth generation mobile communication system. In a wired core network, however, network instrument has been increasingly mounted on general-purpose servers to which virtualization technologies such as SDN and NFV are applied. The SDN stands for software defined network. The NFV stands for network function virtualization.

Conventionally, processing at a higher-level layer with less temporal restriction has been implemented on general-purpose servers, but it is discussed to also implement processing at a lower-level layer with severe temporal restriction onto general-purpose servers along with development in the hardware of general-purpose servers and real-time processing by an OS configured to operate on general-purpose servers. The OS stands for operating system.

In addition, base stations in a wireless network have been discussed as a virtualization target recently. When processing at a lower-level layer, which is performed at base stations, is implemented on general-purpose servers, for example, restriction on processing time and interface for wireless devices cause problems. For example, conventionally, Ethernet has been used as a communication function at a general-purpose server. However, conventionally, at a base station, a dedicated interface such as CPRI has been used for connection between a base station body (wireless control device) configured to perform baseband processing and a wireless unit (wireless device) including an antenna unit.

A packet that has a packet length synchronized with a wireless frequency and in which a synchronization signal is embedded is employed at the dedicated interface such as CPRI. The use of such an interface allows the base station body and the wireless unit to be easily synchronized with each other. However, for example, the use of CPRI requests mounting of dedicated hardware on the general-purpose server, and this request for the dedicated hardware restricts implementation of the base station on the general-purpose server.

To avoid this, Ethernet may be used as an interface between the general-purpose server and the wireless device. For example, when typical interfaces such as TCP/IP and UDP/IP are used in Ethernet, the base station body and the wireless unit request to be synchronized with each other new by a method because these interfaces are not intended to achieve accurate synchronization. The TCP/IP stands for Transmission Control Protocol/Internet Protocol. The UDP/IP stands for User Datagram Protocol/Internet Protocol.

For example, when data is transmitted and received through Ethernet, it is difficult to establish synchronization only through data communication like CPRI because not only user data but also control data and the like are transmitted and received and packets do not include time information. In a method of establishing wireless frame synchronization by detecting the boundary of wireless frames based on the number of pieces of received data, fluctuation in data arrival time causes fluctuation in a detected frame synchronization time.

To avoid the influence of this fluctuation when wireless signal processing is performed, processing requests to be shortened enough to completely absorb the time of the fluctuation, which generates a time in which a CPU of the general-purpose server may not be used. As a result, the CPU of the general-purpose server requests higher processing performance. For example, the number of cores and clock rate of the CPU of the general-purpose server requests to be increased, which causes, for example, increase in signal processing cost and processing power consumption.

However, according to the embodiment described above, for example, when the wireless control device is a general-purpose server connected with the wireless device through a transmission system asynchronous with a wireless frame, decrease in a time for wireless signal processing attributable to fluctuation in data arrival may be reduced. This enables the wireless signal processing with a reduced amount of resource, thereby achieving reduction in power consumption and cost.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A wireless control device comprising:
a communication circuit configured to receive, from a wireless device, a signal wirelessly received by the wireless device; and
a control circuit configured to
store a time at each reception of a given amount of signal by the communication circuit and
perform wireless signal processing of transmitting and receiving a wireless signal through the wireless device, in accordance with a time calculated based on a plurality of stored times.

2. The wireless control device according to claim 1, wherein the control circuit performs the wireless signal processing in accordance with a time calculated through linear approximation based on the plurality of times.

3. The wireless control device according to claim 1, wherein the wireless signal processing includes decoding a signal received by the communication circuit.

4. The wireless control device according to claim 1, wherein the wireless signal processing includes generating a signal to be wirelessly transmitted by the wireless device and transmitting the generated signal to the wireless device.

5. The wireless control device according to claim 1, wherein
the wireless signal processing includes decoding a signal received by the communication circuit, and
the control circuit calculates, based on the plurality of times, a prediction time at which the given amount of signal is received by the communication circuit, and starts the signal decoding processing at a time earlier than the calculated prediction time.

6. The wireless control device according to claim 5, wherein the control circuit starts Fourier transform included in the signal decoding processing at a time earlier than the prediction time.

7. The wireless control device according to claim 5, wherein the communication circuit outputs a signal received from the wireless device to the control circuit in a unit smaller than the given amount.

8. The wireless control device according to claim 1, wherein the communication circuit receives, from the wireless device through a transmission path asynchronous with transmission and reception of the wireless signal, a signal wirelessly received by the wireless device.

9. A wireless device comprising:
a wireless circuit configured to transmit and receive wireless a signal; and
a communication circuit configured to transmit a signal received by the wireless circuit to a wireless control device, the wireless control device being configured to store a time at each reception of a given amount of signal from the wireless device and perform wireless signal processing of transmitting and receiving a wireless signal through the wireless device in accordance with a time calculated based on a plurality of stored times.

10. A base station comprising:
a wireless device; and
a wireless control device,
wherein the wireless device is configured to transmit and receive a wireless signal and configured to transmit a wirelessly received signal to the wireless control device, and
wherein the wireless control device is configured to store a time at each reception of a given amount of signal from the wireless device and perform wireless signal processing of transmitting and receiving wireless signals through the wireless device in accordance with a time calculated based on a plurality of stored times.
